(19) United States
(12) Patent Application Publication
(10) Pub. No.: US 2008/0102195 A1
(43) Pub. Date: May 1, 2008

(54) Compolwax

(76) Inventors: Donald Gemma, Lavallette, NJ (US); Gennaro Pellegrino, Old Tappan, NJ (US)

Correspondence Address: JAMES RAY & ASSOCIATES, 2640 PITCAIRN ROAD, MONROEVILLE, PA, 15146, US

(21) Appl. No.: 11/975,619

(22) Filed: Oct. 19, 2007

Related U.S. Application Data
(60) Provisional application No. 60/854,257, filed on Oct. 25, 2006.

(51) Int. Cl. C09G 1/08; C23C 26/00

(52) U.S. Cl. 427/11; 106/10

(57) ABSTRACT

A liquid formulation suitable for dispensing in a spray bottle for use in detailing an exterior surface of a vehicle. The liquid formulation comprises at least one predetermined rubbing compound for aiding in removal of sanding marks, paint defects and hairline scratches, such at least one predetermined rubbing compound is present in the formulation in a concentration of between about 25 to about 40 percent. A polishing material is included for removal of additional fine scratches and other imperfections, such polishing material being present in the formulation in a concentration of between about 25 to about 40 percent, and a wax is used for providing long lasting protection to a finish of such exterior surface of such vehicle, such wax being present in the formulation in a concentration of between about 25 to about 40 percent. All the above listed percentages are by volume.

### CROSS REFERENCE TO RELATED APPLICATIONS

This application is closely related to and claims benefit from U.S. Provisional Application Ser. No. 60/854,257 filed Oct. 25, 2006.

### FIELD OF THE INVENTION

The present invention relates, in general, to a car treatment, and, more particularly, the present invention relates to a formulated liquid that facilitates the process of detailing the exterior of an automobile or any other vehicle.

### BACKGROUND OF THE INVENTION

Detailing an automobile is an expensive, time-consuming process that can take three or more steps, In order to avoid damage to moldings, rubber, trim and bumpers, the vehicle must first be adequately prepped before the compound is applied. This is usually achieved by the detailer taping or covering these areas to avoid any contact with the compound. Then the detailer must compound the entire vehicle, working small sections at a time, ensuring that the compound does not harden. This is achieved by using a high-speed polisher or buffing pad. Then a polish must be applied and finally a wax and all must be removed from the vehicle in the same manner. The detailer must move around the vehicle at least three times with the different products in order to achieve the desired result. These products must be purchased separately, as well as researching the many different products that are available on the market in order to ensure that the products used are safe and will not harm the vehicle's finish.

Thus, it would be advantageous and convenient if there were a product that does not require all of the steps presently needed to achieve a desired detailing than is currently available.

### SUMMARY OF THE INVENTION

In a first aspect the invention provides a liquid formulation suitable for dispensing in a spray bottle for use in detailing an exterior surface of a vehicle. The liquid formulation comprises at least one predetermined rubbing compound for aiding in removal of sanding marks, paint defects and hairline scratches, such at least one predetermined rubbing compound is present in the formulation in a concentration of between about 25 to about 40 percent by volume. A polishing material is included for removal of additional fine scratches and other imperfections, such polishing material being present in the formulation in a concentration of between about 25 to about 40 percent by volume, and a wax is used for providing long lasting protection to a finish of such exterior surface of such vehicle, such wax being present in the formulation in a concentration of between about 25 to about 40 percent by volume.

In a second aspect the present invention provides a method for detailing an exterior finish of a vehicle. The method comprises the steps of selecting a liquid formulation and then disposing such liquid formulation in a spray bottle for providing detailing of the vehicle exterior finish. There is a step of spraying such formulation selected in a previous step on the exterior surface of such vehicle and then buffing the exterior surface of such vehicle with the formulation applied in a previous step with a buffing pad or by hand.

### OBJECTS OF THE INVENTION

It is, therefore, one of the primary objects of the present invention to provide a formulation for detailing the exterior surface of a vehicle in which the components are all liquids.

Another object of the present invention is to provide a formulation for detailing the exterior surface of a vehicle wherein such formulation contains a rubbing compound, a polish and a wax.

Still another object of the present invention is to provide a method for detailing the exterior surface of a vehicle wherein such formulation is applied to the surface and then machine or hand buffed.

Yet another object of the present invention is to provide a formulation that facilitates the detailing the exterior surface of a vehicle.

Another object of the present invention is to provide a formulation for detailing the exterior surface of a vehicle wherein such formulation can be used as a waterless cleaner and maintenance on all vehicles.

These and various other objects and advantages of this invention will become apparent after a full reading of the following detailed description, particularly, when read in conjunction with the appended claims.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the invention provides a liquid formulation suitable for dispensing in a spray bottle for use in detailing an exterior surface of a vehicle. The liquid formulation comprises at least one predetermined rubbing compound for aiding in removal of sanding marks, paint defects and hairline scratches, such at least one predetermined rubbing compound is present in the formulation in a concentration of between about 25 to about 40 percent by volume. A polishing material is included for removal of additional fine scratches and other imperfections, such polishing material being present in the formulation in a concentration of between about 25 to about 40 percent by volume, and a wax is used for providing long lasting protection to a finish of such exterior surface of such vehicle, such wax being present in the formulation in a concentration of between about 25 to about 40 percent by volume.

In a more preferred embodiment of the invention such at least one predetermined rubbing compound is present in the formulation in a concentration of between about 30 and about 35 percent, such polishing material is present in said formulation in a concentration of between about 30 and about 35 percent and such wax is present in the formulation in a concentration of between about 30 and about 35 percent. The above percentages are all volume percentages.

It is also presently preferred that such at least one predetermined rubbing compound, such polishing material and such wax are all liquids.

In a second aspect the present invention provides a method for detailing an exterior finish of a vehicle. The method comprises the steps of selecting a liquid formulation and then disposing such liquid formulation in a spray bottle for use in detailing the vehicle exterior finish. There is a step of spraying such formulation selected in a previous step on the exterior surface of such vehicle and then buffing the exterior surface of such vehicle with the formulation applied in a previous step with a buffing pad or by hand.

The method further includes a step of selecting a medium grade foam buffing pad for use in buffing the exterior surface of the vehicle as well as by hand.

The method also includes a step of selecting such formulation from a blend of at least one predetermined rubbing compound for aiding in removal of scratches, paint defects and sanding marks, a polishing material and a wax.

There is an additional step of selecting a formulation that is safe for use not only on the finish but is also safe for use on moldings, trim, rims, bumpers, chrome and glass of the vehicle.

It is also presently preferred that there is a step of selecting a formulation wherein all ingredients are liquids.

It is also preferred that the, method includes a step of spraying a section of such exterior surface at one time and buffing that section followed by spraying another section and then buffing that section until such entire surface is completed. It should be noted that the entire surface could be sprayed at one time; however, it is preferred that it be done one section at a time.

Thus, the present invention provides a blend of rubbing compound(s), polishes and waxes which eliminates at least two of the steps normally required in the detailing of a vehicle's exterior. The present invention consists of rubbing compound(s) that enhance the cutting power in the removal of sanding marks, paint defects and hairline scratches; polishes for the removal of additional fine scratches and other imperfections and, finally, waxes that act as a barrier thereby providing long lasting protection to the finish. With the present invention there is no need to prep the vehicle as all of the products used are safe for use on the finish as well as for moldings, trim, rims, chrome, bumpers and glass. To further aid in the detailing process, the present invention is blended together as a liquid that is contained in a convenient, disposable spray bottle. The bottle features an adjustable spray nozzle. To use the product one only has to spray the liquid onto the exterior surface of the vehicle and then buff off. It is preferred is a medium grade foam-buffing pad is used. The product leaves a deep, wet-look shine on the vehicle's finish. It can be used on cars, trucks, planes, boats or RV's or other vehicles. In addition, such product can also be used as a waterless cleaner and maintenance on all vehicles. It can be used by anyone, anywhere in a matter of minutes. It removes tar, bugs, sap and bird droppings while it leaves a swirl-free glossy shine in just minutes. It cleans glass, chrome, rubber, moldings, bumpers and also removes brake dust from rims and hubcaps while it shines and protects.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

We claim:

1. A liquid formulation suitable for dispensing in a spray bottle for use in detailing an exterior surface of a vehicle, said liquid formulation comprising:
(a) at least one predetermined rubbing compound for aiding in removal of sanding marks, paint defects and hairline scratches, said at least one predetermined rubbing compound is present in said formulation in a concentration of between about 25 to about 40 percent by volume;
(b) a polishing material for removal of additional fine scratches and other imperfections, said polishing material being present in said formulation in a concentration of between about 25 to about 40 percent by volume;
(c) a wax for providing long lasting protection to a finish of such exterior surface of such vehicle, said wax being present in said formulation in a concentration of between about 25 to about 40 percent by volume.

2. The formulation, according to claim 1, wherein said at least one predetermined rubbing compound is present in said formulation in a concentration of between about 30 and about 35 percent by volume.

3. The formulation, according to claim 1, wherein said polishing material is present in said formulation in a concentration of between about 30 and about 35 percent by volume.

4. The formulation, according to claim 1, wherein said wax is present in said formulation in a concentration of between about 30 and about 35 percent by volume.

5. The formulation, according to claim 1, wherein said formulation is sprayed onto such exterior surface of such vehicle.

6. The formulation, according to claim 1, wherein said at least one predetermined rubbing compound is a liquid.

7. The formulation, according to claim 1, wherein said polishing material is a liquid.

8. The formulation, according to claim 1, wherein said wax is a liquid.

9. A method for detailing an exterior finish of a vehicle, said method comprising the steps of:
(a) selecting a liquid formulation;
(b) disposing said liquid formulation in a spray bottle for providing detailing of said vehicle exterior finish;
(c) spraying said formulation selected in step (a) on said exterior surface of said vehicle; and
(c) buffing said exterior surface of said vehicle with said formulation applied in step (c) with one of a buffing pad and by hand.

10. The method, according to claim 9, wherein said method further includes a step of selecting a medium grade foam buffing pad for use in buffing said exterior surface of said vehicle.

11. The method, according to claim 9, wherein said method further includes a step of selecting said formulation from a blend of at least one predetermined rubbing compound for aiding in removal of scratches, paint defects and sanding marks, a polishing material and a wax.

12. The method, according to claim 11, wherein said method further includes a step of selecting said formulation that is safe for use not only on said exterior finish of said vehicle but is also safe for use on moldings, trim, rims, bumpers, chrome and glass.

13. The method, according to claim 11, wherein said method further includes a step of selecting said formulation wherein all ingredients are liquids.

14. The method, according to claim 9, wherein said method includes a step of spraying a section of such exterior surface at one time and buffing said section followed by spraying another section and then buffing said another section until such entire surface is completed.
